(19) United States
(12) Patent Application Publication
(10) Pub. No.: US 2026/0051525 A1
(43) Pub. Date: Feb. 19, 2026

(54) BATTERY MANUFACTURING PROCESS MANAGEMENT SYSTEM AND OPERATING METHOD THEREOF

(71) Applicant: LG ENERGY SOLUTION, LTD., Seoul (KR)

(72) Inventor: Hyeon Jin SONG, Daejeon (KR)

(21) Appl. No.: 19/103,549

(22) PCT Filed: Jun. 29, 2023
(86) PCT No.: PCT/KR2023/009170

§ 371 Date: Feb. 12, 2025

(30) Foreign Application Priority Data
Aug. 17, 2022 (KR) 10-2022-0102999

(51) Int. Cl. H01M 10/04; G08B 21/18; H01M 10/633

(52) U.S. Cl. CPC H01M 10/04; G08B 21/185; H01M 10/633

(57) ABSTRACT

A battery manufacturing process management system according to an embodiment includes a battery cell dummy configured to obtain data corresponding to a battery manufacturing process and a controller configured to control at least one process variable related to the battery manufacturing process based on the data corresponding to the battery manufacturing process that is obtained using the battery cell dummy.

### CROSS-REFERENCE TO RELATED APPLICATIONS

This application is a National Phase entry pursuant to 35 U.S. C. 371 of International Application No. PCT/KR2023/009170 filed on Jun. 29, 2023, which claims priority to and the benefit of Korean Patent Application No. 10-2022-0102999 filed in the Korean Intellectual Property Office on Aug. 17, 2022. The entire contents of the aforementioned applications are incorporated herein by reference.

### TECHNICAL FIELD

Embodiments disclosed herein relate to a battery manufacturing process management system and an operating method thereof.

### BACKGROUND

Recently, research and development of secondary batteries have been actively performed. Secondary batteries, which are chargeable/dischargeable batteries, may include all of conventional nickel (Ni)/cadmium (Cd) batteries, Ni/metal hydride (MH) batteries, etc., and recent lithium-ion batteries. Among them, a lithium-ion battery has a much higher energy density than those of conventional Ni/Cd batteries, Ni/MH batteries, etc. Moreover, the lithium-ion battery may be manufactured to be small and lightweight, such that the lithium-ion battery has been used as a power source of mobile devices, and recently, a use range thereof has been extended to power sources for electric vehicles, attracting attention as next-generation energy storage media.

A battery cell, which is the basic unit constituting a battery pack and/or module, includes an anode, a cathode, and a separator. Each battery cell is manufactured through an electrode assembly process, a degassing process, an activation process, a charge/discharge process, an aging process, etc., and performance or completion level of the battery cell may vary depending on process variables such as a pressure applied to the battery cell by pressurization equipment, a temperature inside a chamber, charge/discharge conditions of the battery cell, a leaving period, etc. Conventionally, setting of the process variables highly depends on experiences of technicians, it is difficult to know in advance an influence on the performance or completion level of battery cell products when manufacturing equipment is replaced or equipment settings or conditions are changed.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Embodiments disclosed herein aim to provide a battery manufacturing process management system which may appropriately control process variables by obtaining data about a battery manufacturing process using a battery cell dummy including a sensor.

Embodiments disclosed herein aim to improve performance degradation and defects of a battery cell and reduce a risk originating from a failure by providing a feedback to a user based on a database established for a manufacturing process of a battery.

Technical problems of the embodiments disclosed herein are not limited to the above-described technical problems, and other unmentioned technical problems would be clearly understood by one of ordinary skill in the art from the following description.

A battery manufacturing process management system according to an embodiment includes a battery cell dummy configured to obtain data corresponding to a battery manufacturing process and a controller configured to control at least one process variable related to the battery manufacturing process based on the data corresponding to the battery manufacturing process that is obtained using the battery cell dummy.

In the battery manufacturing process management system according to an embodiment, the data corresponding to the battery manufacturing process may include at least one of a pressure applied to the battery cell dummy, an internal or external temperature of the battery cell dummy, an internal gas volume of the battery cell dummy, and a deformation level of the battery cell dummy.

In the battery manufacturing process management system according to an embodiment, the battery cell dummy may include at least one of a pressure sensor configured to measure the pressure applied to the battery cell dummy, a temperature sensor configured to sense the internal or external temperature of the battery cell dummy, a gas volume sensor configured to measure the internal gas volume of the battery cell dummy, and a strain gauge configured to sense the deformation level of the battery cell dummy.

In the battery manufacturing process management system according to an embodiment, the pressure sensor and the temperature sensor may be pad-type sensors included in the battery cell dummy, and the strain gauge may be a film-type sensor attached to a surface of the battery cell dummy.

In the battery manufacturing process management system according to an embodiment, the controller may be further configured to adjust the at least one process variable based on the data obtained using the battery cell dummy.

In the battery manufacturing process management system according to an embodiment, the at least one process variable may include at least one of: a setting of pressurization equipment, a chamber internal temperature, a battery storage period, and a battery charge/discharge condition.

In the battery manufacturing process management system according to an embodiment, the controller may be further configured to transmit an alert message to a user based on a difference between the data obtained using the battery cell dummy and previously stored reference data.

A battery manufacturing process management method according to an embodiment may include obtaining data corresponding to a battery manufacturing process using a battery cell dummy and controlling at least one process variable related to the battery manufacturing process based on the data corresponding to the battery manufacturing process that is obtained using the battery cell dummy.

In the battery manufacturing process management method according to an embodiment, the data corresponding to the battery manufacturing process may include at least one of: a pressure applied to the battery cell dummy, an internal or external temperature of the battery cell dummy, an internal gas volume of the battery cell dummy, and a deformation level of the battery cell dummy.

In the battery manufacturing process management method according to an embodiment, obtaining of the data corresponding to the battery manufacturing process using the battery cell dummy may include measuring the pressure applied to the battery cell dummy, sensing the internal or external temperature of the battery cell dummy, measuring the internal gas volume of the battery cell dummy, and sensing the deformation level of the battery cell dummy.

In the battery manufacturing process management method according to an embodiment, a pad-type sensor included in the battery cell dummy is utilized to perform at least one of: the measuring of the pressure, the sensing of the temperature, and the measuring of the internal gas volume, and a film-type sensor attached to a surface of the battery cell dummy is utilized to sense the deformation of the battery cell dummy.

In the battery manufacturing process management method according to an embodiment, controlling the at least one process variable may include adjusting the at least one process variable based on the data obtained using the battery cell dummy.

In the battery manufacturing process management method according to an embodiment, the at least one process variable may include at least one of: a setting of pressurization equipment, a chamber internal temperature, a battery storage period, and a battery charge/discharge condition.

The battery manufacturing process management method according to an embodiment may further include transmitting an alert message to a user based on a difference between the data obtained using the battery cell dummy and previously stored reference data.

According to an embodiment, by previously putting a battery cell dummy including a sensor into a battery manufacturing process, data (e.g., a pressure applied to a cell, a temperature, a gas volume, a deformation level, etc.) regarding a process may be obtained and a process database may be established based on the data.

According to an embodiment, by calculating optimal process variables (e.g., setting of pressurization equipment, a chamber temperature, charge/discharge conditions, etc.) and controlling process variables in a battery manufacturing process, a risk associated with equipment replacement or new process line installation may be minimized.

According to an embodiment, by providing a feedback to the user based on the established database, performance degradation and defects of the battery cell due to the process variables may be prevented and improved.

Moreover, various effects recognized directly or indirectly from the disclosure may be provided.

### BRIEF DESCRIPTION OF THE DRAWINGS

The accompanying drawings illustrate preferred embodiments of the present disclosure and together with the foregoing disclosure, serve to provide further understanding of the technical features of the present disclosure, and thus, the present disclosure is not construed as being limited to the drawings.

FIG. 1 shows a configuration of a battery manufacturing process management system according to an embodiment.

FIG. 2A is a side view of a battery cell dummy according to an embodiment.

FIG. 2B is a plane view of a battery cell dummy according to an embodiment.

FIG. 3 shows a flow of a battery manufacturing process management method according to an embodiment.

FIG. 4 shows in detail an operation of obtaining data in a battery manufacturing process management method according to an embodiment.

FIG. 5 shows a flow of a battery manufacturing process management method according to an embodiment.

FIG. 6 shows a computing system that executes a battery manufacturing process management method according to an embodiment.

### DETAILED DESCRIPTION

Hereinafter, embodiments disclosed in this document will be described in detail with reference to the exemplary drawings. In adding reference numerals to components of each drawing, it should be noted that the same components are given the same reference numerals even though they are indicated in different drawings. In addition, in describing the embodiments disclosed in this document, when it is determined that a detailed description of a related known configuration or function interferes with the understanding of an embodiment disclosed in this document, the detailed description thereof will be omitted.

Although terms used herein are selected with general terms popularly used at present under the consideration of functions in the disclosure, the terms may vary according to the intention of those of ordinary skill in the art, custom, or introduction of new technology. In addition, in a specific case, the applicant voluntarily may select terms, and in this case, the meaning of the terms may be disclosed in a corresponding description part of the present specification. Therefore, the terms used herein should be defined not by the simple names of the terms but by the substantial meaning of the terms and the contents throughout the disclosure.

Terms defined in the present disclosure are used for only describing a specific exemplary embodiment and may not have an intention to limit the scope of other exemplary embodiments. It is to be understood that the singular forms include plural references unless the context clearly dictates otherwise. Herein, expressions such as “first” and “second” are used to distinguish components from each other, and do not mean a rank or order among components.

All components constituting the embodiment have been described as being combined or operating in combination, but it is not necessarily limited to this embodiment, and within the scope of the purpose, all components may be selectively combined with one or more to operate. Moreover, terms such as “include”, “constitute”, “have”, etc., described herein may mean that the corresponding component may be inherent unless otherwise stated, and thus should be construed as further including other components rather than excluding other components.

Moreover, components shown in the block diagram are classified depending on their functions and roles, and each block does not necessarily have to be implemented as independent hardware or software. For example, separated components may be actually implemented as one device or program, or one component may be implemented as a combination of several devices and programs.

Hereinbelow, preferred embodiments of a battery manufacturing process management system and an operating method thereof will be described with reference to the drawings.

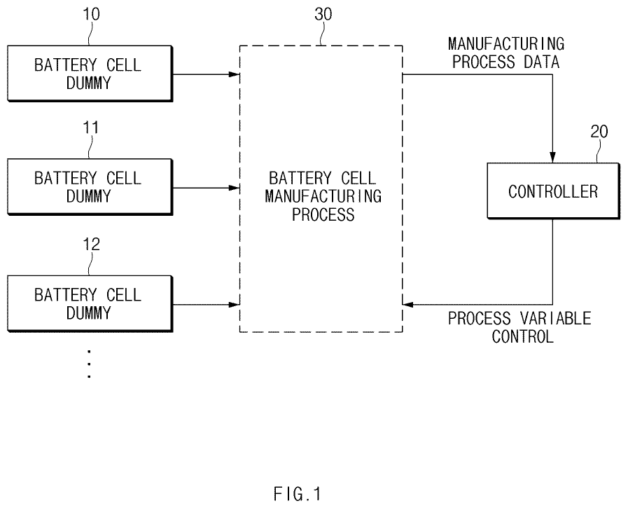

FIG. 1 shows a configuration of a battery manufacturing process management system according to an embodiment.

Referring to FIG. 1, a battery manufacturing process management system according to an embodiment may include battery cell dummies 10, 11, 12, . . . , for obtaining data regarding a battery manufacturing process and a controller 20 for controlling at least one process variable related to the battery manufacturing process based on the data obtained using the battery cell dummy.

The battery cell dummies 10, 11, 12, . . . , may be imitations manufactured with the same specifications (size, specifications, etc.) as an actual battery cell product, and may be put into a battery cell manufacturing process 30 for use to obtain the data regarding the manufacturing process.

A battery cell mentioned herein may be a basic unit forming a battery pack or a battery module. Each battery cell is manufactured through an electrode assembly process, a degassing process, an activation process, a charge/discharge process, an aging process, etc., and performance or completion level of a product may vary depending on process variables (e.g., a pressure applied to the battery cell, a temperature inside a chamber, charge/discharge conditions, etc.). Conventionally, setting of the process variables highly depends on experiences of technicians, it is difficult to know in advance an influence on the performance or completion level of battery cell products when manufacturing equipment is replaced or equipment settings or conditions are changed.

The battery cell dummies 10, 11, 12, . . . , may be put into the battery cell manufacturing process 30 and obtain data regarding a battery manufacturing process such as a pressure applied to a battery cell dummy, an internal or external temperature of the battery cell dummy, an internal gas volume of the battery cell dummy, a deformation level of the battery cell dummy, etc., while passing through the same process as an actual battery cell, and the obtained data may be transmitted to the controller 20.

According to an embodiment, the battery cell dummies 10, 11, 12, . . . , each may include at least one sensor for obtaining the process-related data. For example, a pressure sensor for measuring the pressure applied to the battery cell dummy, a temperature sensor for sensing an internal or external temperature of the battery cell dummy, a gas volume sensor for measuring a gas volume inside the battery cell dummy, a strain gauge for sensing deformation of the battery cell dummy, etc., may be included in the battery cell dummy or installed on the surface of the battery cell dummy.

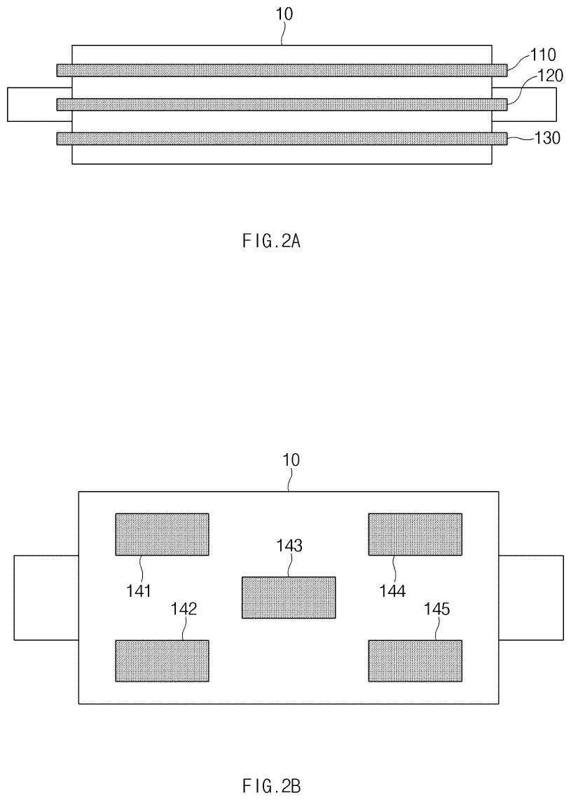

FIG. 2A is a side view of a battery cell dummy according to an embodiment.

As is shown, the battery cell dummy 10 may include at least one pad-type sensors 110, 120, and 130. The sensors 110, 120, and 130 may correspond to a pressure sensor, a temperature sensor, a gas volume sensor, etc., respectively. For example, the pressure sensor 110 may measure a pressure applied to the battery cell dummy 10 from external equipment in a manufacturing process and a pressure applied from an inside due to expansion or deformation of the battery cell dummy 10, the temperature sensor 120 may measure an internal temperature or a temperature of an external environment of the battery cell dummy 10, and the gas volume sensor 130 may sense a gas volume generated inside the battery cell dummy 10.

FIG. 2B is a plane view of a battery cell dummy according to an embodiment.

As is shown, the battery cell dummy 10 may include at least one strain gauges 141 to 145 for sensing deformation of the battery cell dummy 10. According to an embodiment, the strain gauge, which is a device configured to detect a mechanical subtle change as an electric signal, may be a film-type sensor attached to an upper surface of the battery cell dummy 10.

According to an embodiment, the sensors 110, 120, and 130 and the strain gauges 141 to 145 each may transmit measurement data to the controller 20 through a communication unit capable of wireless communication (Bluetooth, Wi-Fi optical communication, RF communication, etc.,) with an external device. Alternatively, a storage device included in the battery cell dummy 10 may collect data obtained by the sensor and transmit the measurement data to the controller 20 through the communication unit. Alternatively, the sensors and the strain gauge may transmit the obtained data to an external device (e.g., a cloud PC, etc.) instead of the controller 20, and the controller 20 may obtain data regarding a battery manufacturing process from the external device through separate communication.

Configurations and positions of the battery cell dummy 10 and the sensor included in the same, shown in FIGS. 2A and 2B, are merely examples, and various sensors (e.g., an image sensor, a magnetic sensor, a current sensor, etc.) not mentioned specifically herein may be used to obtain the process-related data.

Referring back to FIG. 1, the battery cell dummies 10, 11, 12, . . . , may be sequentially put into the battery cell manufacturing process 30 and each obtain data (a pressure, a temperature, a gas volume, a deformation level, etc.) regarding a battery manufacturing process. Data obtained using the plurality of battery cell dummies may be stored in a process database through labelling, and may be used by the controller 20 to calculate optimal values for the process variables and control the process variables.

The controller 20 may control at least one process variable based on manufacturing process data of a battery obtained using the battery cell dummies 10, 11, 12, . . . .

The process variable (or design variable) may be set by a manufacturer in the battery manufacturing process and may affect performance, quality, etc., of the battery. For example, the process variable may include setting of the pressurization equipment, a temperature inside the chamber, a battery storage period/temperature, a battery charge/discharge condition, etc. The process variables affect a state of the manufactured battery cell, and more specifically, setting of the pressurization equipment may affect a pressure applied to a battery cell, an internal temperature of a chamber or a battery storage temperature may affect an internal/external temperature of the battery, and the charge/discharge condition of the battery (charge current/voltage, the number of cycles, a period, etc.) may affect an internal gas volume or temperature of the battery.

According to an embodiment, the controller 20 may optimize at least one process variable based on data of the battery obtained using the battery cell dummies 10, 11, 12, . . . , For example, an environment (equipment settings, chamber temperature, charge/discharge conditions, etc.) of a manufacturing process of a battery having specific specifications may be optimized to manufacture the battery with desired performance and completion level. Conventionally, in this state, for example, when a process environment changes due to introduction of new equipment, installation of an additional line, a change in an external temperature/humidity, etc., the same process variables are applied or some adjustment is possible depending on the technician's experiences, in spite of a change in the environment, but the optimal result is difficult to obtain as before.

On the other hand, with the battery manufacturing process management system according to an embodiment, the battery cell dummy may be put into the manufacturing process to obtain data after a change in the process environment, and the optimal process variables (e.g., setting for manufacturing the same product as before the change in the environment) may be calculated and applied through comparison with existing process data, thereby obtaining the same process result as before.

According to an embodiment, the controller 20 may transmit an alert message to the user based on a difference between data obtained using the battery cell dummies 10, 11, 12, . . . , and previously stored reference data. For example, by referring to a setting value of the pressurization equipment, an alert message (“over allowable pressure”) may be output to the user when a pressure value applied to a battery cell dummy exceeds an allowable pressure value, thereby preventing a loss occurring in manufacturing of the actual battery cell. In another example, when an internal gas volume or temperature and a deformation level of the battery cell dummy may be compared with allowable gas volume, temperature, and deformation value, respectively, and exceed the allowable values, then the alert message may be output in advance to the user, thereby preventing a loss occurring in manufacturing of the actual battery cell. The alert message may be output by a display device connected to the controller 20.

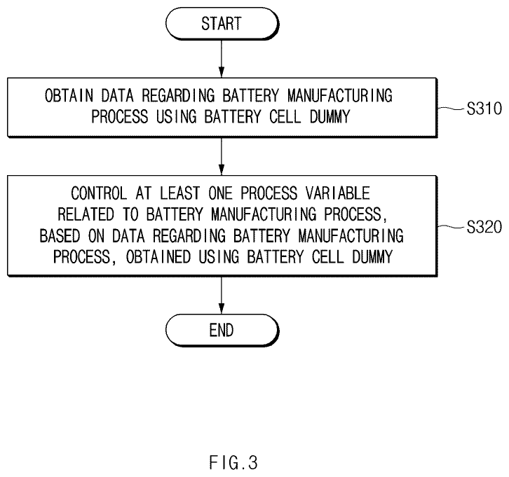

FIG. 3 shows a flow of a battery manufacturing process management method according to an embodiment.

Referring to FIG. 3, in operation S310, data regarding a battery manufacturing process may be obtained using a battery cell dummy. The battery cell dummy may be imitations manufactured with the same specifications (size, specifications, etc.) as an actual battery cell product, and may be put into the battery cell manufacturing process for use to obtain the data regarding the manufacturing process.

According to an embodiment, the data regarding the battery manufacturing process may include at least one of a pressure applied to the battery cell dummy, an internal or external temperature of the battery cell dummy, an internal gas volume of the battery cell dummy, and a deformation level of the battery cell dummy.

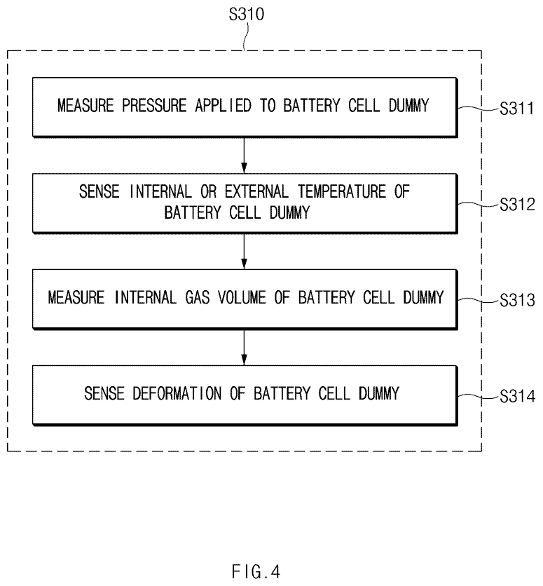

FIG. 4 shows in detail an operation of obtaining data in a battery manufacturing process management method according to an embodiment.

Referring to FIG. 4, operation S310 of obtaining the data regarding the battery manufacturing process may include operation S311 of measuring the pressure applied to the battery cell dummy, operation S312 of sensing an internal or external temperature of the battery cell dummy, operation S313 of measuring an internal gas volume of the battery cell dummy, and operation S314 of sensing deformation of the battery cell dummy. However, operations S311 to S314 may not be simultaneously or sequentially performed, and some thereof may be performed or may be performed in an order different from that shown.

According to an embodiment, at least one of operation S311 to S313 may be performed by a pad-type sensor included in the battery cell dummy (e.g., the pressure sensor 110, the temperature sensor 120, the gas volume sensor 130, etc., of FIG. 2A0, and operation S314 may be performed by a film-type sensor attached to the surface of the battery cell dummy (e.g., the strain gauges 141 to 145, etc., of FIG. 2B).

Referring back to FIG. 3, in operation S320, at least one process variable related to the battery manufacturing process may be controlled based on manufacturing process data obtained using the battery cell dummy. The process variable may be set by a manufacturer in the battery manufacturing process and may affect performance, quality, etc., of the battery. For example, the process variable may include setting of the pressurization equipment, a temperature inside the chamber, a battery storage period/temperature, a battery charge/discharge condition, etc. The process variables affect a state of the manufactured battery cell, and more specifically, setting of the pressurization equipment may affect a pressure applied to a battery cell, an internal temperature of a chamber or a battery storage temperature may affect an internal/external temperature of the battery, and the charge/discharge condition of the battery (charge current/voltage, the number of cycles, a period, etc.) may affect an internal gas volume or temperature of the battery.

According to an embodiment, operation S320 of controlling the at least one process variable may include optimizing the at least one process variable based on the data obtained using the battery cell dummy. On the other hand, when the process environment changes due to introduction of new equipment, installation of an additional line, a change in an external temperature/humidity, etc., the battery cell dummy may be put into the manufacturing process to obtain data, and the optimal process variables (e.g., setting for manufacturing the same product as before the change in the environment) may be calculated and applied through comparison with existing process data, thereby obtaining the same process result as before.

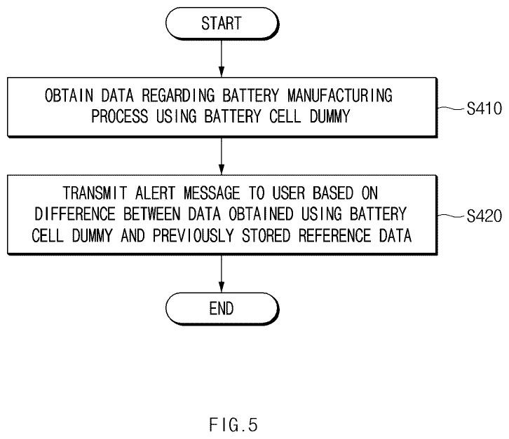

FIG. 5 shows a flow of a battery manufacturing process management method according to an embodiment.

Referring to FIG. 5, in operation S410, data regarding a battery manufacturing process may be obtained using a battery cell dummy. Operation S410 is similar to operation S310 of FIG. 3 and thus will not be described in detail.

In operation S420, an alert message may be transmitted to a user based on a difference between the data obtained using the battery cell dummy and the previously stored reference data. For example, by referring to a setting value of the pressurization equipment, an alert message (“allowable pressure exceeded”) may be output to the user when a pressure value applied to a battery cell dummy exceeds an allowable pressure value, thereby preventing a loss occurring in manufacturing of the actual battery cell. In another example, when an internal gas volume or temperature and a deformation level of the battery cell dummy may be compared with allowable gas volume, temperature, and deformation value, respectively, and exceed the allowable values, then the alert message may be output in advance to the user, thereby preventing a loss occurring in manufacturing of the actual battery cell.

The battery manufacturing process management method described with reference to FIGS. 3 to 5 so far may be performed by the battery manufacturing process management system described above, but may also be performed by a device or system having other configurations, without being limited thereto.

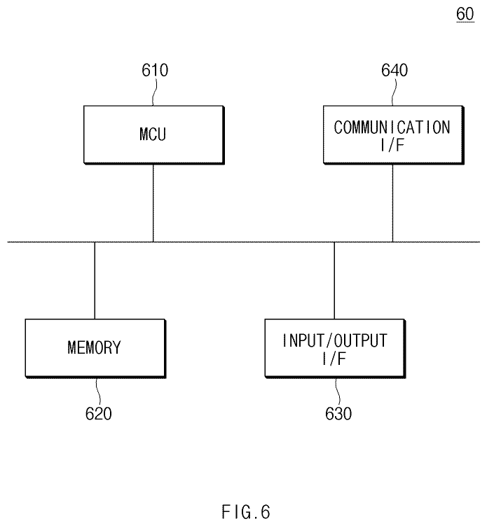

FIG. 6 shows a computing system that executes a battery manufacturing process management method according to an embodiment.

Referring to FIG. 6, a computing system 60 according to an embodiment disclosed herein may include an MCU 610, a memory 620, an input/output I/F 630, and a communication I/F 640.

The MCU 610 may be a processor for executing various programs stored in the memory 620 and executing the above-described battery manufacturing process management method through these programs.

The memory 620 may store various programs related to diagnosis of the battery, etc. The memory 620 may be provided in plural, depending on a need. The memory 620 may include volatile or nonvolatile memory. For the memory 620 as the volatile memory, random access memory (RAM), dynamic RAM (DRAM), static RAM (SRAM), etc., may be used. The memory 620 as the nonvolatile memory may be read only memory (ROM), programmable ROM (PROM), electrically alterable ROM (EAROM), erasable PROM (EPROM), electrically erasable PROM (EEPROM), flash memory, etc. The above-listed examples of the memory 620 are merely examples and are not limited thereto.

The input/output I/F 630 may provide an interface for transmitting and receiving data by connecting an input device (not shown) such as a keyboard, a mouse, a touch panel, etc., and an output device such as a display (not shown), etc., to the MCU 610.

The communication I/F 630, which is a component capable of transmitting and receiving various data to and from a server, may be various devices capable of supporting wired or wireless communication. For example, programs for predicting the remaining life of a battery or learning an artificial neural network or various data may be transmitted and received to and from a separately provided external server through the communication I/F 630.

The battery manufacturing process management method according to the embodiments may be implemented in the form of an application or a program instruction that is executable through various computer components and recorded in a computer-readable recording medium. The computer-readable recording medium may include a program instruction, a data file, a data structure and the like solely or in a combined manner.

With the battery manufacturing process management system and method according to an embodiment described above, by previously putting a battery cell dummy including a sensor into a battery manufacturing process, data (e.g., a pressure applied to a cell, a temperature, a gas volume, a deformation level, etc.) regarding a process may be obtained and a process database may be established based on the data. Moreover, by calculating optimal process variables (e.g., setting of pressurization equipment, a chamber temperature, charge/discharge conditions, etc.) and controlling process variables in a battery manufacturing process, a risk associated with equipment replacement or new process line installation may be minimized. Furthermore, by providing a feedback to the user based on the established database, performance degradation and defects of the battery cell due to the process variables may be prevented and improved.

The above description is merely illustrative of the technical idea of the present disclosure, and various modifications and variations will be possible without departing from the essential characteristics of embodiments of the present disclosure by those of ordinary skill in the art to which the embodiments disclosed herein pertains.

Therefore, the embodiments disclosed herein are intended for description rather than limitation of the technical spirit of the embodiments disclosed herein and the scope of the technical spirit of the present disclosure is not limited by these embodiments disclosed herein. The protection scope of the technical spirit disclosed herein should be interpreted by the following claims, and all technical spirits within the same range should be understood to be included in the range of the present disclosure.

1. A battery manufacturing process management system comprising:
a battery cell dummy configured to obtain data corresponding to a battery manufacturing process; and
a controller configured to control at least one process variable related to the battery manufacturing process based on the data corresponding to the battery manufacturing process, that is obtained using the battery cell dummy.

2. The battery manufacturing process management system of claim 1, wherein the data corresponding to the battery manufacturing process comprises at least one of: a pressure applied to the battery cell dummy, an internal or external temperature of the battery cell dummy, an internal gas volume of the battery cell dummy, and a deformation level of the battery cell dummy.

3. The battery manufacturing process management system of claim 2, wherein the battery cell dummy comprises at least one of:
a pressure sensor configured to measure the pressure applied to the battery cell dummy;
a temperature sensor configured to sense the internal or external temperature of the battery cell dummy;
a gas volume sensor configured to measure the internal gas volume of the battery cell dummy; and
a strain gauge configured to sense the deformation level of the battery cell dummy.

4. The battery manufacturing process management system of claim 3, wherein the pressure sensor and the temperature sensor are pad-type sensors included in the battery cell dummy, and
the strain gauge is a film-type sensor attached to a surface of the battery cell dummy.

5. The battery manufacturing process management system of claim 1, wherein the controller is further configured to adjust the at least one process variable based on the data obtained using the battery cell dummy.

6. The battery manufacturing process management system of claim 5, wherein the at least one process variable comprises at least one of: a setting of pressurization equipment, a chamber internal temperature, a battery storage period, and a battery charge/discharge condition.

7. The battery manufacturing process management system of claim 5, wherein the controller is further configured to transmit an alert message to a user based on a difference between the data obtained using the battery cell dummy and the-previously stored reference data.

8. A battery manufacturing process management method comprising:
obtaining data corresponding to a battery manufacturing process using a battery cell dummy; and
controlling at least one process variable related to the battery manufacturing process based on the data corresponding to the battery manufacturing process that is obtained using the battery cell dummy.

9. The battery manufacturing process management method of claim 8, wherein the data corresponding to the battery manufacturing process comprises at least one of: a pressure applied to the battery cell dummy, an internal or external temperature of the battery cell dummy, an internal gas volume of the battery cell dummy, and a deformation level of the battery cell dummy.

10. The battery manufacturing process management method of claim 9, wherein the obtaining of the data corresponding to the battery manufacturing process using the battery cell dummy comprises:
measuring the pressure applied to the battery cell dummy;
sensing the internal or external temperature of the battery cell dummy;
measuring the internal gas volume of the battery cell dummy; and
sensing the deformation level of the battery cell dummy.

11. The battery manufacturing process management method of claim 10, wherein a pad-type sensor included in the battery cell dummy is utilized to perform at least one of: measuring of the pressure, sensing of the internal or external temperature, and measuring of the internal gas volume, and
a film-type sensor attached to a surface of the battery cell dummy is utilized to sense the deformation level of the battery cell dummy. sensor

12. The battery manufacturing process management method of claim 8, wherein controlling the at least one process variable comprises adjusting the at least one process variable based on the data obtained using the battery cell dummy.

13. The battery manufacturing process management method of claim 12, wherein the at least one process variable comprises at least one of: a setting of pressurization equipment, a chamber internal temperature, a battery storage period, and a battery charge/discharge condition.

14. The battery manufacturing process management method of claim 12, further comprising transmitting an alert message to a user based on a difference between the data obtained using the battery cell dummy and the previously stored reference data.
